(19) United States
(12) Patent Application Publication
(10) Pub. No.: US 2020/0102130 A1
(43) Pub. Date: Apr. 2, 2020

(54) DAUBER APPLICATOR ASSEMBLY AND A MULTI-LAYERED CONTAINER FOR SOLVENT CEMENT PRODUCTS

(71) Applicant: PIDILITE INDUSTRIES LIMITED, Mumbai (IN)

(72) Inventor: Madhukar Balvantray PAREKH, Mumbai (IN)

(21) Appl. No.: 16/576,194

(22) Filed: Sep. 19, 2019

(30) Foreign Application Priority Data
Sep. 28, 2018 (IN) 201821036772

(51) Int. Cl. B65D 51/32; B65D 41/04; B65D 1/02; B32B 27/36; B32B 27/30; B32B 27/32; B32B 27/08; B29C 70/72; B32B 1/02; B05C 1/00; B29C 70/68

(52) U.S. Cl. CPC B65D 51/32; B29K 2705/00; B65D 1/0215; B32B 27/36; B32B 27/306; B32B 27/32; B32B 27/08; B29C 70/72; B32B 1/02; B05C 1/00; B29C 70/683; B32B 2250/24; B32B 2250/05; B32B 2439/60; B65D 41/04

(57) ABSTRACT

Disclosed is a cap 101 and a plastic multilayer container 601 for solvent cement products. Further, the cap 101 comprises a cavity 102. The cavity may be configured to accommodate a metal dauber applicator comprising a metal dauber applicator wire 104, wherein the wire 104 comprises a first end 302 and a second end 304, wherein the first end 302 may be fitted with cotton blob 105. Further, the second end 304 may be shaped. The system 600 may comprise a holding means 103, molded over at second end 304. Further, the holding means 103 is configured to be press fitted in the cavity 102, thereby forming the cap 101 and the metal dauber assembly. Further, the cap 101 may comprise internal threads 106, which enables the cap 101 to be screwed onto a plastic multilayer container 601.

### CROSS-REFERENCE TO RELATED APPLICATIONS AND PRIORITY

The present application claims priority from Indian Patent Application Number 201821036772 Filed on 28 Sep. 2018.

### TECHNICAL FIELD

The present subject matter described here, in general relates to a cap with additional fitment, and more specifically related to a cap with dauber applicator and a method of manufacturing a plastic multilayer container for the cap with dauber applicator.

### BACKGROUND

Plastic pipes such as acrylonitrile butadiene (ABS), Chlorinated polyvinyl chloride (CPVC) and polyvinyl chloride (PVC) pipes are primarily joined by solvent cementing (i.e. by adhesive solvent cement materials). A proper gluing of solvent cement to the surface requires a good quality dauber applicator. Such applicators and containers of solvent cement are manufactured with good quality raw materials as daubers and containers continuously come in contact with the solvent cement gluing liquids. Thus, there is requirement of durable and easy to handle applicator with a good quality container. The existing packaging (i.e. tin containers) used for packing solvent cement face problems of rusting, denting and also may cause injury to the finger while removing product from tin container due to inside sharp edges of tin container.

A long-lasting solvent cementing requires rapid application of correct amount of solvent cement with consistent quality of primers and cements. The length of metal dauber is designed as per container size. The Stock keeping unit SKU) wise metal dauber wire lengths and cotton blob diameter is designed in such a way that there will be no wastage of the product when removed the product from the container. Also, different application surfaces required applicator daubers with different lengths. Very small or very large length of applicator may not apply sufficient amount of solvent cement to the targeted surface. Existing dauber fitment systems with cap and container may have problems regarding the applicator and container durability in many aspects. Existing dauber cap applicators are mainly made up of complete plastic molding with fixed length, metal cap with welded/soldered daubers. It remains a tedious task to fix a metal dauber with a plastic cap by welding or soldering, as there is a possibility of deformation of cap or loose connection of dauber with the cap. Also, a fixed length soldered/welded metal shaft may not remain useful for all length requirements of applicator.

Further, the container material of solvent cement also affects the durability of solvent cement. The material used for plastic multilayer container of the solvent cement must comprise chemical resistant properties. Further, it is desired that the container is non-reactive, rust and dent proof, as well as the inner surface further improving the shelf life and property consistency of solvent to be stored in the container. Existing tin container face problems such as rusting, denting and shorter shelf life.

Therefore, it is necessary to construct a full featured plastic multilayer container for solvent cement with a plastic cap and metal dauber connected to the plastic cap, wherein the plastic cap is constructed in such way that metal dauber with multiple lengths can be fitted in the cap, depending on the size of the container.

### SUMMARY

This summary is provided to introduce concepts related to plastic cap metal dauber fitment system with plastic multilayer container. This summary is not intended to identify essential features of the claimed subject matter nor is it intended for use in determining or limiting the scope of the claimed subject matter.

In one embodiment, a metal dauber assembly enabled to fit over a plastic multilayer container is described. The assembly may comprise a cap, wherein the cap may be a plastic cap. The system may comprise a cavity inside the plastic cap. The metal dauber applicator wire comprises a first end and a second end, wherein the first end may be configured to hold a cotton blob. Further, the second end of the metal dauber applicator wire may be shaped into a pattern. The pattern may correspond to a zig-zag, a sinuous, a tilt, a wave, a S-shape, a crooked structure, an angular bend and the like. Further, a holding means may be molded over at second end of the metal dauber applicator wire, wherein the holding means is molded in such way that the holding means press fits in the cavity.

In one embodiment, a plastic multilayer container with a metal dauber applicator wire and cap is described. The plastic multilayer container may comprise a first layer inner layer of solvent resistant, chemical resistant thermoplastic polymeric layer. The plastic multilayer container may comprise a second tie layer of thermoplastic resin polymer. The plastic multilayer container may comprise a third central layer of mixture of a high-density polyethylene (HDPE), a thermoplastic polymer and a thermoplastic adhesive resin polymer. The plastic multilayer container may comprise a fourth layer of tie layer, wherein the tie layer may comprise of adhesive resin polymer. The plastic multilayer container may further comprise a fifth outer layer of thermoplastic high-density polyethylene (HDPE). In one embodiment, the third layer/central layer is produced by reusing scrap trimmed from the multi-layered container during a blow molding process.

In one embodiment, a method of manufacturing of complete bottle comprising cap with metal dauber and plastic multilayer container is described. The method may comprise a first step of Shaping the ends and the structure of metal dauber applicator wire. The method may comprise a second step of Molding of holding means over metal dauber applicator wire. The method may comprise a third step of fitting of a cotton blob to metal wire. The method may comprise a fourth step of assembling of holding means in a cavity of a cap. The method may comprise a fifth step of fitting of cap assembled with metal applicator dauber over the multi-layered container. The method thereby may comprise a sixth step of manufacturing of complete bottle with cap, metal dauber and plastic multilayer container.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a dauber applicator 100 comprising a cap 101 with a metal dauber applicator wire 104.

FIG. 2 illustrates a fitment of a metal dauber holder 103 in to a cavity 102 of the cap 101.

FIG. 3 illustrates a first end 302 and a second end 304 of a metal dauber applicator wire 104.

FIG. 4 illustrates an assembly 400 of a metal dauber holder 103 and the metal dauber applicator wire 104.

FIG. 5 illustrates a magnified disclosure of fitment of the metal dauber holder 103 to the cavity 102 of the cap 101.

FIG. 6 illustrates a bottle assembly with the cap 101 and a plastic multilayer container.

FIG. 7 shows illustration of five-layer of the plastic multilayer container.

FIG. 8 illustrates a flow chart 800 of method of manufacturing of assembly of bottle with the cap 101, a metal dauber applicator wire 104 and the plastic multilayer container.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

Referring now to FIG. 1, a dauber applicator 100 comprising a cap 101 with a metal dauber applicator wire 104 is illustrated. In one embodiment the cap 101 may be a plastic cap. In one embodiment, a cavity 102 may be formed inside the cap 101. The cap 101 may comprise an internal thread 106. Further, the assembly 100 may comprise a metal dauber applicator wire 104, wherein the metal dauber applicator wire 104 is fitted with cotton blob at first end. The assembly 100 may comprise a holding means 103, molded over at second end of the metal applicator dauber wire 104, wherein the holding means 103 is molded in such way that the holding means 103 press fits in the cavity 102 of the cap 101.

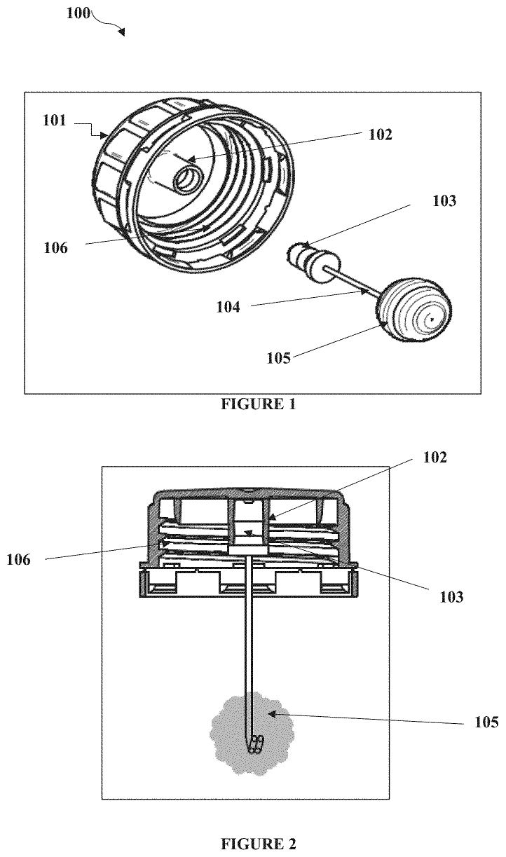

Referring to FIG. 2, fitment of the metal dauber holder 103 into the cavity 102 of the cap 101, is illustrated. The fitment may eliminate welding/soldering process of the metal dauber applicator wire 104 to the cap 101 of the container and may further facilitate the use of same fitment for one or more lengths of metal dauber applicator wire 104. The length of metal dauber applicator wire may range within 1 cm to 150 cm.

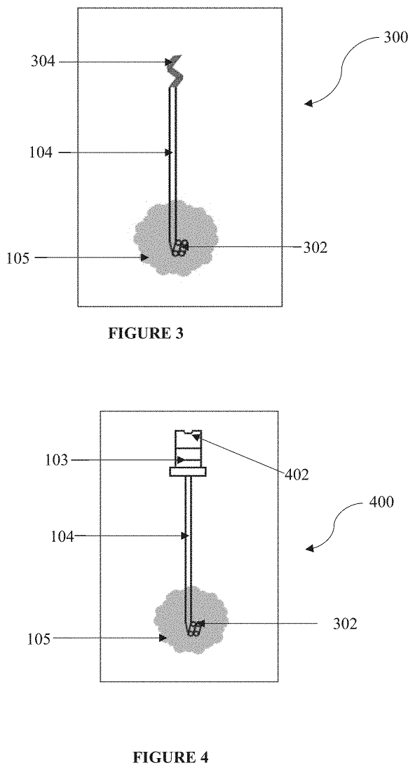

Referring to FIG. 3, a first end 302 and a second end 304 of a metal dauber applicator wire 104 is illustrated. The first end 302 may be shaped into a hook like structure to hold a cotton blob 105. Further, the second end 304 may be shaped into a pattern, wherein the pattern is selected from a zig-zag, a sinuous, a tilted, a wave, or a S-curvature, a crooked structure, an angular bend and the like.

In an embodiment, as illustrated in FIG. 4, the metal dauber applicator wire 104 may be shaped in S-shape at the second end 304 and further molded into the holding means 103, wherein the holding means 103 is configured to snap fit into the cavity 102 of the cap 101. A hook at the first end 302 of metal dauber applicator wire 104 may be enabled to attach cotton blob 105 or any other applicator brush. In one embodiment, the depression 402 may be formed at the bottom surface of the holding means 103. The depression 402 may be linear depression. The depression 402 helps in ease of press fitting the holding means 103 into the cavity 102.

In an embodiment, the second end 304 of the metal dauber applicator wire 104 may be molded to the holding means 103 by over-molding, or plastic-to-metal molding process.

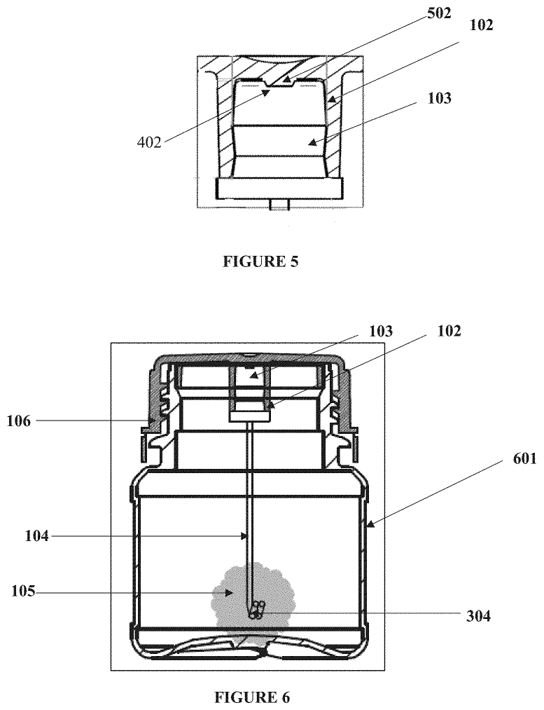

In one embodiment, refer to FIG. 5, the holding means 103 of metal dauber applicator wire 104 may be fitted to the cavity 102 of the cap 101 by any one of the press fitting, snap fitting, fastening, snap-fastening, force fitting, interlock, lock and key fitting method. In one embodiment, the cap 101 may be made of polymeric material with pilfer proof ring, inbuilt plug and the cavity 102. In one embodiment, the cavity 102 may comprise a swelling 502. The swelling 502 may be configured to exactly match the shape of the depression 402. After the holding means 103 is pressed into the cavity 102, the swelling 502 and the depression 402 perfectly fit such that the circular motion of the holding means 103 is prevented even if the metal dauber applicator wire 104 is bent during application.

In one embodiment, the plastic material of the cap 101, cavity 102 and holding means 103 may be molded from a thermoplastic polymeric material, High density polyethylene (HDPE), low density polyethylene (LDPE), Polyethylene, polypropylene, polyvinyl chloride, polystyrene, polybenzimidazole, acrylic, nylon and Teflon, ethylene vinyl alcohol (EVOH). Further, the holding means 103 may be of a cylindrical shape, which may be fastened/press-fitted into the cavity 102 in the cap 101.

Referring to FIG. 6, a plastic multilayer container 601 is illustrated. In one embodiment, the plastic multilayer container 601 with a metal dauber applicator wire 104 and cap 101 is described. The plastic multilayer container 601 may comprise a five-layer assembly further facilitating durability to the container 601. The plastic multilayer container 601 may comprise rust resistance, non-reactivity to inner solvent cement, chemical resistance, dent proof properties and longer shelf life of the inner solvent up to 2-3 years of storage.

In one embodiment, the plastic multilayer container 601 may by of solvent storage capacity and size of 1 ml to 1200 ml and more particularly, stock kipping units of 50 ml, 100 ml, 250 ml, 500 ml and 1 litre containers.

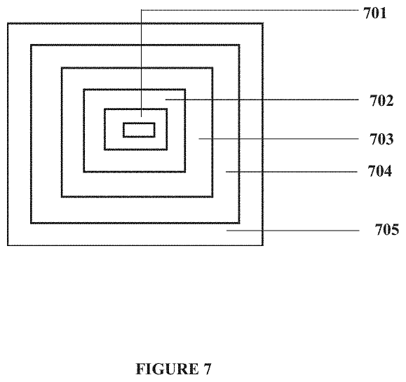

Referring now to FIG. 7, layers 700 of the plastic multilayer container 601, are illustrated. The plastic multilayer container 601 may comprise a first layer inner layer 701 of solvent resistant, chemical resistant thermoplastic polymeric layer, nylon, ethylene vinyl alcohol (EVOH), wherein the polymeric material is non-reactive with cement/primer solvent material. The plastic multilayer container may comprise a second tie layer 702 of thermoplastic resin polymer. The plastic multilayer container may comprise a third central layer 703 of mixture of a high-density polyethylene (HDPE), a thermoplastic polymer and a thermoplastic adhesive resin polymer, wherein the central third layer 703 may improve the shelf life and durability of the solvent cement inside the container. In one embodiment, central third layer 703 is composed of waste material obtained during blow mounding of the plastic multilayer container 601. The same waste material is reused as central third layer 703. The plastic multilayer container may comprise a fourth layer 704 of tie layer, wherein the tie layer may comprise of adhesive resin polymer. The plastic multilayer container may further comprise a fifth outer layer 705 of thermoplastic high-density polyethylene (HDPE).

In one embodiment the thickness of the first inner layer 701 may range within 40-50 micron. In one embodiment the thickness of the second 702 and fourth 704 tie layer may range within 20-30 micron. The thickness of the third central layer 703 comprising mixture of thermoplastic high-density polyethylene (HDPE), chemical resistant thermoplastic polymeric material and thermoplastic adhesive resin tie layer may range within 350-500 micron. The thickness of fifth layer 705 (outer layer of the container) may range within 400-600 microns. The thickness of the layers of the container may further vary depending upon the size of the stock kipping units (size of bottles/closures/container) as per sizes of containers such as 50 ml, 100 ml, 250 ml, 500 ml and 1000 ml.

In one embodiment, the inner layer of solvent resistant, chemical resistant thermoplastic polymeric material may include but not limited to high density polyethylene (HDPE), low density polyethylene (LDPE), Polyethylene, polypropylene, polyvinyl chloride, polystyrene, polybenzimidazole, acrylic, nylon and Teflon, ethylene vinyl alcohol (EVOH), Cellulose, and Chlorinated polyvinyl chloride.

In one embodiment the second 702 and the fourth 704 tie layer may comprise an intermediate adhesive resin material. The tie layer polymeric material may include but not limited to Adhesive Resins, Ethylene-vinyl acetate (EVA), Ethylene-methyl acrylate (EMA), Ethylene-acrylic acid (EAA), and Ethylene-grafted-maleic anhydride (AMP), Modified Polyolefins and the like.

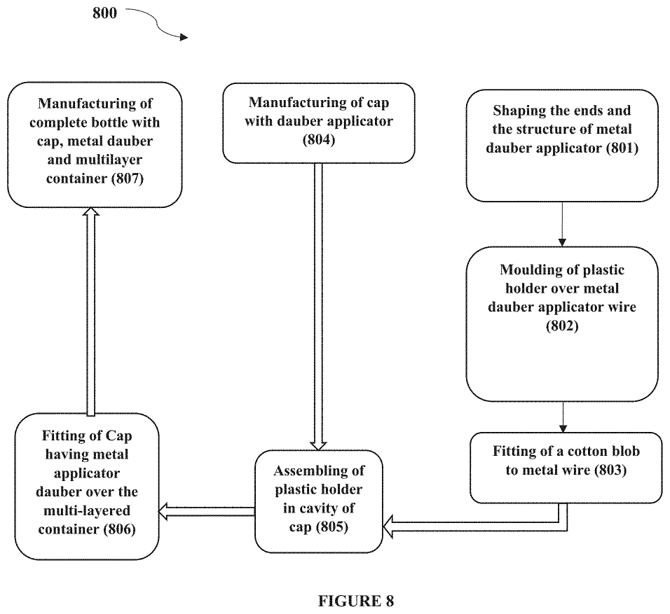

Referring to FIG. 8, a method 800 of manufacturing of complete bottle assembly comprising a cap 101 with metal dauber applicator wire 104 and plastic multilayer container 601 is described. The method may comprise a first step 801 of Shaping of metal dauber applicator wire 104. The method may comprise a second step 802 of moulding of holding means 103 over metal dauber applicator wire 104. The method may comprise a third step 803 of fitting of a cotton blob to metal wire. The method may comprise a fourth step 804 of manufacturing of cap with dauber applicator. The method may comprise a fifth step 805 of assembling of holding means 103 in a cavity 102 of a cap 101. The method may comprise a sixth step 806 of fitting of the cap cavity 101 assembled with metal dauber applicator wire 104 over the plastic multi-layered container 601. The method thereby may comprise a seventh step 807 of manufacturing of complete bottle with cap, metal dauber and plastic multilayer container.

In one embodiment, the five-layer container 601 and other plastic materials described in the present disclosure may be manufactured by molding, roll-to roll molding, injection molding, extrusion molding, roll and blow molding, stretch blow molding and coextrusion processes.

In one exemplary embodiment, the solvent cement inside the multilayer container 601 may comprise a wide range of gluing materials, adhesives materials, binders, cosmetics, primers, solvents, heavy body solvent cement, sealants, sealing agents, cement paste, grease, and liquids.

In one embodiment, shaping the second end 304 of the metal dauber applicator wire 104 into a pattern and molding the holding means 103 over the second end 304 may provide a strong fixation of the metal dauber applicator wire 104, and may permit the slipping out of the metal dauber applicator wire 104 from the holding means 103.

The foregoing description shall be interpreted as illustrative and not in any limiting sense. A person of ordinary skill in the art would understand that certain modifications could come within the scope of this disclosure. The embodiments, examples and alternatives of the preceding paragraphs or the description and drawings, including any of their various aspects or respective individual features, may be taken independently or in any combination. Features described in connection with one embodiment are applicable to all embodiments, unless such features are incompatible.

We claim:

1. A dauber applicator, comprising:
a container cap (101);
a dauber metal applicator wire (104), wherein the metal applicator wire (104) comprises a first end (302) and a second end (304), the first end (302) is shaped to hold a cotton blob (105), characterized in that the second end (304) is shaped, wherein a holding means (103) is moulded over the second end (304), and wherein the holding means (103) is shaped for fitting in a cavity (102) within the container cap (101).

2. The dauber applicator as claimed in claim 1, wherein the first end (302) is hook shaped for holding the cotton blob (105).

3. The dauber applicator as claimed in claim 1, wherein the second end (304) is shaped into a pattern selected from a zig-zag pattern, a sinuous pattern, a tilt, a wave, an S-shape, a crooked structure, and angular bend.

4. The dauber applicator as claimed in claim 1, wherein the holding means (103) is a plastic holder of cylindrical shape.

5. The dauber applicator as claimed in claim 1, wherein the container cap comprises an internal threading (106) and is configured to be screw fitted to a container (601) providing closing means to the container.

6. The fitment applicator as claimed in claim 5, wherein the container (601) is a plastic multi-layered container comprising a five-layered material assembly enabled to store the adhesive solvent.

7. The fitment applicator as claimed in claim 5, wherein the five-layered material assembly of the plastic multi-layer container comprises a first layer/inner layer (701) of solvent resistant, chemical resistant thermoplastic polymeric material selected from nylon or ethylene vinyl alcohol (EVOH), wherein the polymeric material is non-reactive to cement/primer solvent material, wherein the five-layered material assembly comprises a second layer/tie layer (702) and fourth layer/tie layer (704) of thermoplastic resin polymer, wherein the five-layered material assembly comprises a third layer/central layer (703) of mixture of a high-density polyethylene (HDPE), a thermoplastic polymer and a thermoplastic adhesive resin polymer, wherein the third layer/central layer (703) improves the shelf life and durability of the solvent cement inside the container, wherein the third layer/central layer (703) is composed of waste material obtained during blow mounding of the plastic multilayer container (601), wherein the five-layered material assembly comprises a fifth layer/outer layer (705) of thermoplastic high-density polyethylene (HDPE).

8. The dauber applicator as claimed in claim 1, wherein the cavity (102) is in a hollow cylindrical form.

9. The dauber applicator as claimed in claim 1, wherein the holding means (103) is shaped for press fitting, snap fitting, fastening, snap-fastening, force fitting, interlock, lock and key fitting in the cavity.

10. The dauber applicator as claimed in claim 1, wherein the holding means (103) comprises an extruded tip, configured to fit into grooves of the cavity (102) via interference fit.

11. The dauber applicator as claimed in claim 5, wherein the material of the holding means (103) is selected from a group of a thermoplastic polymeric material, High density polyethylene (HDPE), low density polyethylene (LDPE), Polyethylene, polypropylene, polyvinyl chloride, polystyrene, polybenzimidazole, acrylic, nylon and Teflon, and ethylene vinyl alcohol (EVOH).

12. The dauber applicator as claimed in claim 1, wherein the holding means is moulded over the second end (304) of the metal dauber applicator wire (104) by an over-moulding process.

13. A method for manufacturing a dauber applicator assembly, the method comprising steps of:
shaping a metal dauber applicator wire (104), wherein a first end (302) of the metal dauber applicator wire (104) is formed into a hook shape and a second end (304) is shaped;
molding a holding means (103) over the metal dauber applicator wire (104), wherein the holding means is molded over the second end (304) of the metal dauber applicator wire (104);
fitting a cotton blob (105) to metal dauber applicator wire (104), wherein the cotton blob (105) is fitted to the first end (302) of metal dauber applicator wire (104);
fastening the holding means (103) in a cavity (102) of a cap (101) by at least one of snap fitting, press fitting, snap fitting, fastening, snap-fastening, force fitting, interlock, lock and key fitting in the cap cavity (102); and
assembling the cap (101), assembled with metal applicator dauber (104), over a plastic multi-layered container (601).
